(19) United States
(12) Patent Application Publication
(10) Pub. No.: US 2006/0271674 A1
(43) Pub. Date: Nov. 30, 2006

(54) SERVER DEVICE, MANAGEMENT METHOD AND PROGRAM PRODUCT

(76) Inventor: Atsushi Harada, Yamato-shi (JP)

Correspondence Address: IBM CORPORATION;INTELLECTUAL PROPERTY LAW, 11400 BURNET ROAD, AUSTIN, TX, 78758, US

(21) Appl. No.: 11/420,048

(22) Filed: May 24, 2006

(30) Foreign Application Priority Data
May 25, 2005 (JP) 2005152061

(51) Int. Cl. G06F 15/173

(52) U.S. Cl. 709/224

(57) ABSTRACT

[Object] An interrupted session is taken over to another session by using a general method without depending on the kind of application programs.

[Solution] A server device for performing a process according to a request from a terminal device. The server device is able to bring a plurality of sessions concurrently in processing, and processes a session process request received from the terminal. Then, the server device stores status information indicating a process status of a session corresponding to each of the sessions being in processing. Subsequently, the server device determines whether or not the process is to be taken over from a first session to a second session, in the plurality of the sessions Subsequently, the server device updates a second status information of the second session with a first status information of the first session based on the decision

### TECHNICAL FIELD

The present invention relates to a server device, a management method and a program. More specifically, the present invention relates to a server device, a management method and a program for managing a session which is started by a request from a terminal.

### BACKGROUND OF THE INVENTION

In recent years, the World Wide Web has come into use not only for providing information to unspecified users, but also for serving for business relying on communication among specified users. For example, in a commodity sales site, a web server authenticates a user by allowing the user to input his/her ID and password. Then, if the authentication is successful, the web server displays commodities and the like on a browser and allows the user to choose. Information on the commodities chosen by the user is stored in the memory of the web server as selected commodity candidates in relation to the user. From the user's point of view, it seems that they are inside a so-called “shopping cart”. Subsequently, the web server receives a purchase order from the user, and resisters the purchased commodities in a database. Then, an order process server and a payment process server, for example, start their processes.

The web server of this sort accepts a plurality of order inputs from users, and carries out a plurality of processes according to the order inputs. That is, for example, every time a user selects a commodity, the web server displays an image of the commodity in the “shopping cart”. In this instance, since one user may start a plurality of web browsers in some cases, it is not appropriate to manage the status of the processes in relation only with users. Therefore, conventionally, the web server manages a series of processes, which are co-related each other, as one session. For example, every time the web server receives a communication start request, it generates a new session ID and notifies the web browser of the session ID. The web browser includes the session ID in communication data, and sends it to the web server. When the web server receives the communication data from the web browser, it is possible to determine to which session the communication data belongs by reading the session ID included in the communication data. Conventionally, a web browser stores a session ID notified from a web server for an appropriate period of time in order to continue the session properly. For example, the web browser obtains a session ID from the web server when the web browser is started, and discards it when the web browser is closed. Thereby, the user can restart the process from the beginning by closing the web browser. On the other hand, the web server stores a status of the process for the session corresponding to the session ID. Then, the web server discards the status of the session when the process of the session do not progress for a fixed period of time even if the session is not finished. Thereby, a session which is no longer required due to closure of the browser is ended, and a storage area in the web server can be released. The following Patent Publication will be explained later. Japanese Unexamined PCT Publication No. 2001-525574

As described above, when the web browser is closed, the session is also ended no matter whether the user is intending to close the session or not. However, since an operation of closing the web browser is quite easy, a user is likely to close the browser by mistake. In such a case, even though the status of the process so far is managed in the web server, the status of the process can not be continued by taking it over. The status of the process can not be taken over even when the deletion of the session ID is caused by some kind of malfunction, as well as by the erroneous operation of the user. Japanese Unexamined PCT Publication No. 2001-525574, listed above, proposes a technique for continuing a transaction from a certain point by recording a process status every time it reaches to certain points (for example, refer to the paragraph 48 thereof). A typical processing example with regard to a technique for allowing the interruption and restarting of a transaction, such as the technique disclosed in the above-described Publication, is shown below.

FIG. 11 is a view illustrating a conventional method for interrupting and resuming a transaction. A first transaction is started by login of a user, and closed by logout of the user. During the first transaction, status information indicating the process status is recorded sequentially in memory. The status information is stored into a database system at time of logout. Also, the status information is stored in the database system periodically during the first transaction.

After the first transaction is ended, if the user logs in again, a second transaction is started. At the start of the second transaction, status information on the user is loaded from the database system. Thereby, in the second transaction, the process interrupted in the first transaction can be restarted.

In this technique, timing of a process storage is determined by an application program processing the transaction. That means, for example, that a developer of an application program has designed a timing of a process storage and a data type to be stored so as to suit its processing. Therefore, in some cases, a development process of the application program has been significantly increased, and an expense and a period for the development for an upgrade or an alternation of the design has been also increased. Therefore, an object of the present invention is to provide a server device, a management method and a program which are able to solve the above problems. The object is achieved by the combination of characteristic portions of the independent claims of the scope of claims. The dependent claims also regulates more effective specific examples of the present invention.

### SUMMARY OF THE INVENTION

In order to solve the above problems, in one aspect of the present invention, it provides a server device performing a process according to a request received from a terminal, a management method and a program for managing a session in the server device, the server device including: a process portion which is able to bring a plurality of sessions concurrently in processing, and processes a session process request received from the terminal; a storage portion for storing status information indicating a process status of the session, in correspondence to each of the plurality of sessions being in processing; a determination portion for determining whether or not the process is to be taken over from a first session to a second session in the plurality of sessions; and a takeover portion for updating a second status information corresponding to the second session with a first states information corresponding to the first session, based on the determination of the determination portion.

An outline of the present invention is not an enumeration of the all necessary characteristics of the present invention. A subcombination of the characteristics thereof may also be included as the present invention.

According to the present invention, a process of an interrupted session can be taken over to or succeeded by another session by using a general method that does not depend on the kind of application programs.

### BRIEF DESCRIPTION OF THE DRAWINGS

FIG. 1 is a view illustrating an overall total configuration of an information processing system 10.

FIG. 2 is a function block diagram illustrating functions of the server device 20-1.

FIG. 3 is a view illustrating an example of a data structure of the storage portion 220.

FIG. 4 is a flow chart illustrating an example of a process flow of the server 20-1 FIG. 5 is a flow chart illustrating an example of a process flow when the server 20-1 takes over the process of the first session.

FIG. 6 is a flow chart illustrating an example of a process for determining a condition whether or not the first session is taken over in the server 20-1.

FIG. 7 is a view illustrating an example of a login screen displayed in the terminal device 15 by the display portion 270.

FIG. 8 is a view illustrating an example of the options for selecting whether or not the first session is taken overt being displayed in the terminal device 15 by the display portion 270.

FIG. 9 is a timing chart of the process which is taken over from the first session to the second session.

FIG. 10 is a block diagram illustrating an example of a hardware configuration of the information process device 500 serving as the server device 20-1.

FIG. 11 is a timing chart of a process of a conventional technique.

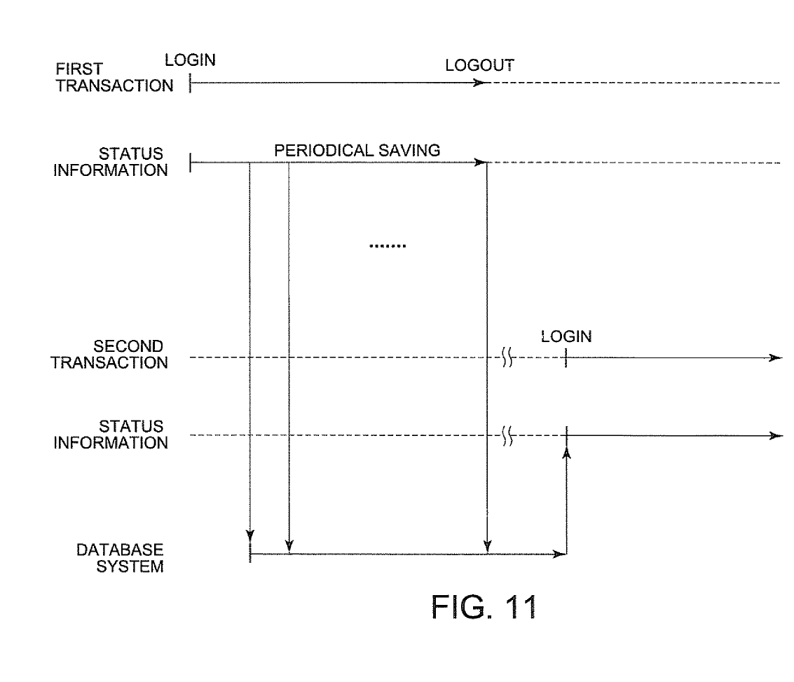

### DETAILED DESCRIPTION OF THE PREFERRED EMBODIMENT

Hereinafter, the present invention is described through a preferred embodiment of the present invention. The embodiment described below does not limit the invention described in the scope of claims, nor are all the combinations of the characteristics described in the embodiment always necessary to the effectiveness of the present invention.

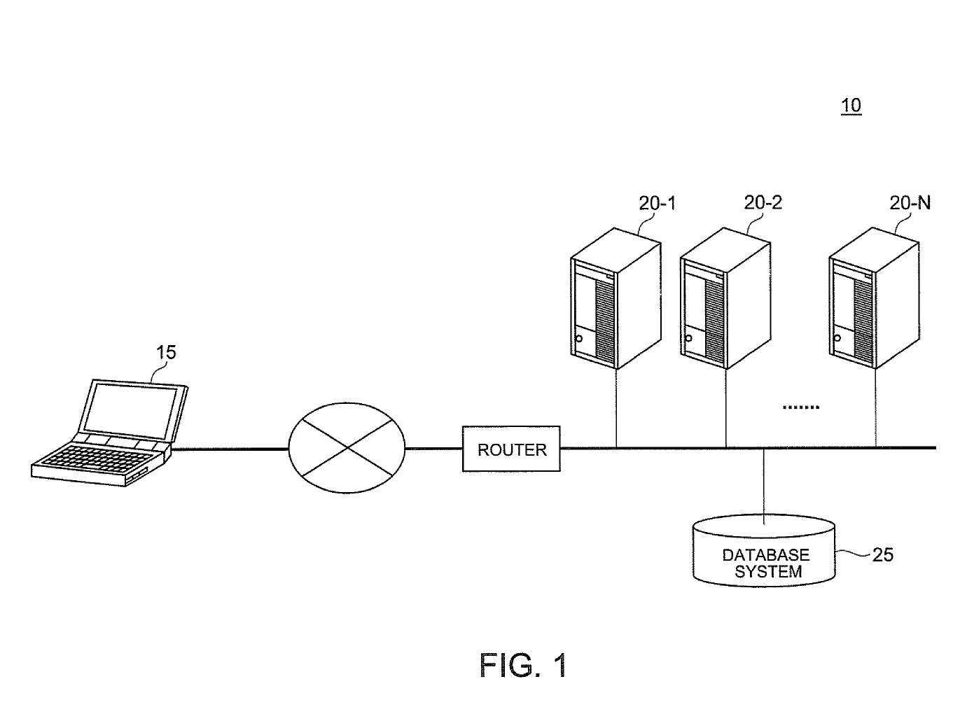

FIG. 1 shows the overall configuration of an information processing system 10. The information processing system 10 includes a terminal device 15, server devices 20-1 to 20-N, and a database system 25. The terminal device 15 is connected to the server devices 20-1 to 20-N via a communication network such as the Internet. The server devices 20-1 to 20-N provide a service in the web together with the database system 25. The server devices 20-1 to 20-N and the database system 25 in the illustrated embodiment are separate devices housed in individual units. Alternatively, at least one part of the server devices 20-1 to 20-N and the database system 25 may be configured in one unit as one device. That is, the devices configured in one unit operates a plurality of software servers such as JVM (Java Virtual Machines), and each of the software server may perform as servers 20-1 to 20-N respectively.

The terminal device 15 operates a web browser to accept an order input from a user, and send the order to one of the server devices 20-1 to 20-N. For example, the terminal device 15 may send a session process request designating a URL (Uniform Resource Locator) to one of the server devices 20-1 to 20-N. Any one of the server devices 20-1 to 20-N (for example, the server device 20-1) performs an operation according to the request received from the terminal device 15. More specifically, the server device 20-1 starts processing a session according to the session process request received from the terminal 15, and the session process progresses according to a subsequently received order.

The server device 20-1 stores status information indicating intermediate process steps of the session in a storage portion of the server device 20-1. Then, when the server device 20-1 receives an explicit order from the user during the session, the server device 20-1 records the process result in the database system 25. Instead of the server device 20-1, any one of the server devices 20-2 to 20-N may also perform the process. The server device for processing the session may be selected from the server devices 20-1 to 20-N, for example, based on process load when a session request is received.

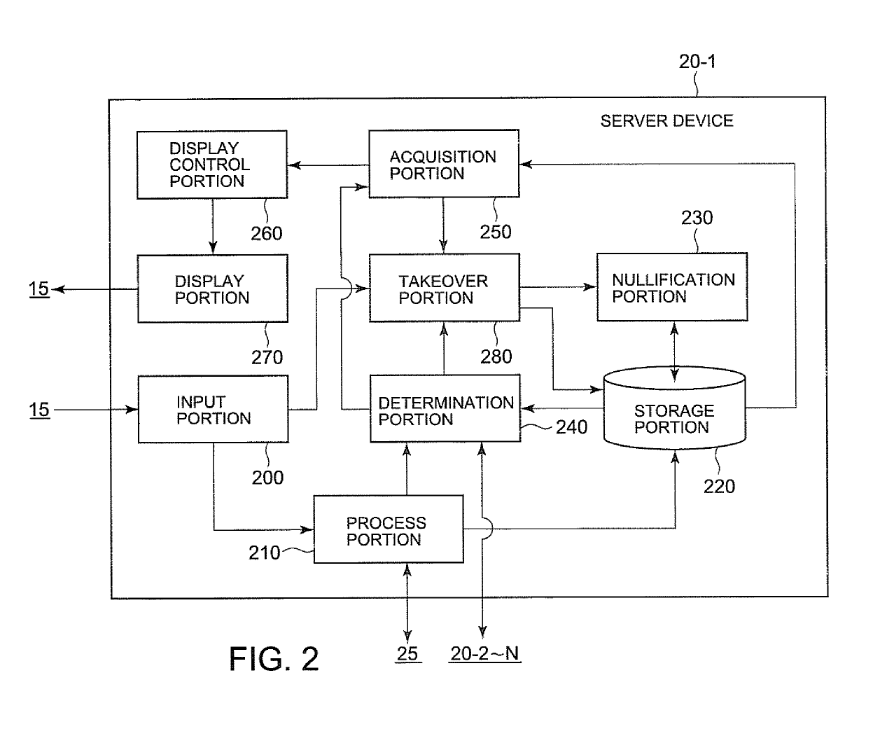

FIG. 2 shows a function block diagram for illustrating functions of the server device 20-1. The server 20-1 includes an input portion 200, a process portion 210, a storage portion 220, a nullification portion 230, a determination portion 240, an acquisition portion 250, a display control portion 260, a display portion 270, and a takeover portion 280. The input portion 200 receives inputs of various orders and requests from the terminal device 15. The process portion 210 is able to bring a plurality of sessions concurrently in processing, and starts processing a session according to a session process request received from the terminal 15. Also, the process portion 210 receives a login request from the user during the session, and allows the user to log in. The login request includes the identification information of the user, for example, a user ID and a password. Moreover, the process portion 210 is able to allow a plurality of users to log in concurrently.

Here, a session means a series of processes which are performed according to orders from the same web browser, without a spacing more than a predetermined time period. For example, a session starts when identification information of a session (hereinafter referred to as a session ID) different from a session ID of a session which has already started is received from the terminal device 15. And the session ends when a predetermined timeout period has elapsed since the session ID was last received.

The storage portion 220 stores status information indicating process status of a session, in correspondence to each of the sessions being in processing, and identification information of the user logging into the server device 20-1 provided in corresponddence with that session. The nullification portion 230 nullifies, in each of the sessions being in processing, the status information corresponding to that session if there is no progress in the process of the session during a predetermined timeout period. For example, the nullification portion 230 may release an area in the storage portion 220 storing the status information to make it available for reusing. In this case, the session is ended. Also, the nullification portion 230 may nullify the session based on an explicit order received from the takeover portion 280.

It is assumed that a first session has already been started by the process portion 210 and the process is progressing. It is also assumed that a second session is newly started by the process portion 210. The determination portion 240 determines whether or not the process of the first session is taken over to the second session, based on a fact that the first session is being processed and the second session is started. More specifically, the determination portion 240 determines to take over the process of the first session to the second session under the condition that the first session and the second session have the same identification information assigned thereto. Preferably, the determination portion 240 determines to take over the process of the first session to the second session under the further condition that the process status of the first session progresses more than the process status of the second session. If the same identification information is not assigned to the first session and the second session, the determination portion 240 may further determine whether or not the identification information is stored in a storage portion of the server devices 20-2 to 20-N. The acquisition portion 250 acquires an elapsed time which elapsed without progress of the first session under the condition that the identification information of the user logging in is already stored in the storage portion 220 in relation to the first session. For example, the acquisition portion 250 may calculate the elapsed time based on data in the storage portion 220.

The display control portion 260 controls display of the display portion 270.

The display portion 270 displays options for the user based on the control of the display control portion 260. More specifically, the display portion 270 generates data for the options to be displayed on the terminal device 15, and sends the same to the terminal device 15 to display the options thereon. For example, the display portion 270 displays an option indicating taking over the process of the first session, and an option indicating starting a new process without taking over the process of the first session, under the condition that the identification information of the user logging in the second session is already stored in the storage portion 220, in correspondence to the first session. The display control portion 260 may control, for example, the order of displaying the options.

The takeover portion 280 updates a second status information corresponding to the second session with a first status information corresponding to the first session in the storage portion 220, based on the determination of the determination portion 240.

In this figure, the function of the server device 20-1 is described as a representative of the server devices 20-1 to 20-N. Each of the server devices 20-2 to 20-N has the same function as the server device 20-1 and thus the description of these server devices is omitted.

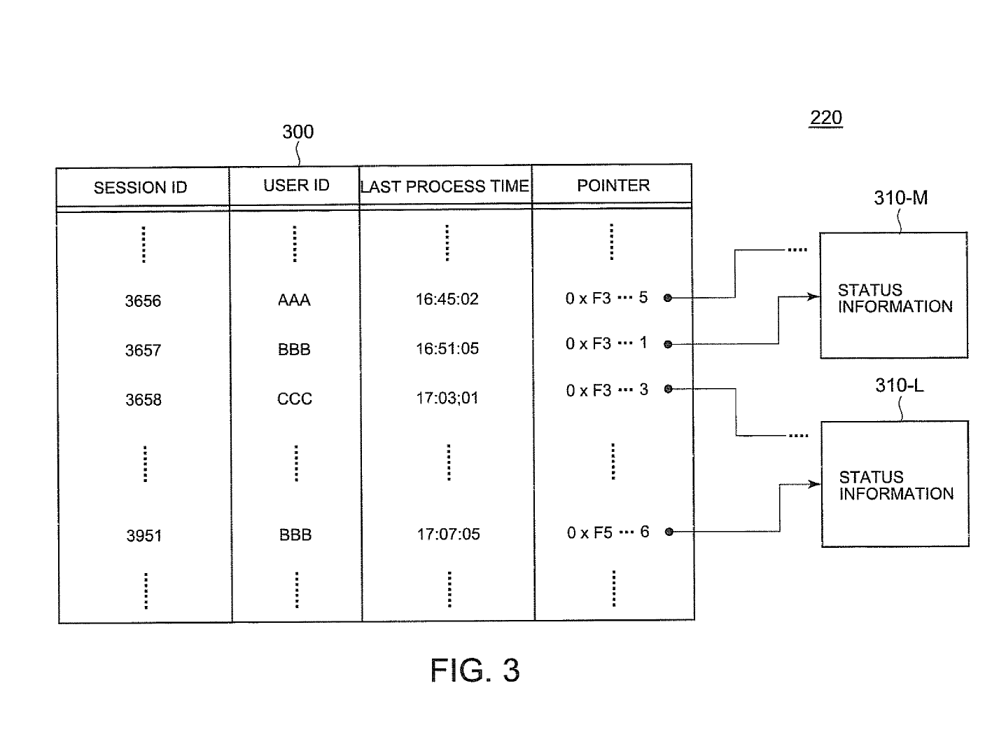

FIG. 3 shows an example of a data structure of the storage portion 220. The storage portion 220, for example, is realized by a nonvolatile recording medium, such as a RAM 1020 described later. Then the recording portion 220 includes a status information record area 310-M and a status information record area 310-L each of which is an example of a first area, and a session information storage area 300 as an example of a second area. The session information storage area 300 is provided for the sessions being in processing and stores identification information of each session (session ID), identification information of a user (user ID) logging into the server device 20-1 for each session, and a last time (last process time) of the progress of the process of the sessionng. Also, the session information storage area 300 stores a pointer for the corresponding status information record area, corresponding to each of the sessions being in processing.

The status information record area 310-L and the status information record area 310-M are established corresponding to each of the sessions being in processing, and store the status informations of the sessions. For example, the process information record area 310-M is provided in relation to a session whose session ID is 3657. Also, the session information storage area 300 stores the pointer for the status information record area 310-M in relation to the session whose session ID is 3657. Each of the status information storage areas is secured when the corresponding session is started, and released when the session is ended. The status information record area 310-L and the status information record area 310-M are areas in which usual application program temporarily stores its process status, and are so-called working memories. That is, these areas are secured by a web server no matter whether or not a takeover function for a session described in this embodiment is provided.

The process portion 210 starts a session process according to a session process request received from the terminal device 15. In this instance, the process portion 210 stores a new session ID in the storage portion 220, and stores a pointer for a newly secured status information storage area in relation to the new session ID. Let the session ID be 3951, and its status information storage area is the status information recording area 310-L. When the user logs into the server device 20-1 in the second session, the determination portion 240 detects the user ID. Let this be BBB. The determination portion 240 determines whether or not the user ID is already stored in the storage portion 200 in relation to the first session. In the example of this figure, the determination portion 240 determines whether or not the BBB, the user ID of the second session, is already stored in relation to the first session. The determination portion 240 determines that the BBB is already stored in relation to the session ID 3657. Therefore, the takeover portion 280 updates the second status information of the second session based on the first status information of the first session.

More specifically, the takeover portion 280 may store a pointer for a status information storage area for the first session as a pointer for a status information storage area for the second session in the session information storage area 300. In the example of this figure, the takeover portion 280 may store a pointer for the status information record area 310-M, instead of the status information record area 310-L, as a pointer for the session ID 3951. Instead, the takeover portion 280 may copy the content of the status information from the status information recording area 310-M to the status information recording area 310-L. In this instance, the takeover portion 280 selects and reads out predetermined information among the information stored in the status information recording area 310-M, and overwrites corresponding information inside the status information recording area 310-L with the predetermined information. Specifically, the takeover portion 280 may take over only the operation history of the user or the process history of the application program, without taking over information identifying a language and an area for the user. Thereby, if the user restarts a session from another terminal device, the process information may be restarted in a form suitable to the terminal device.

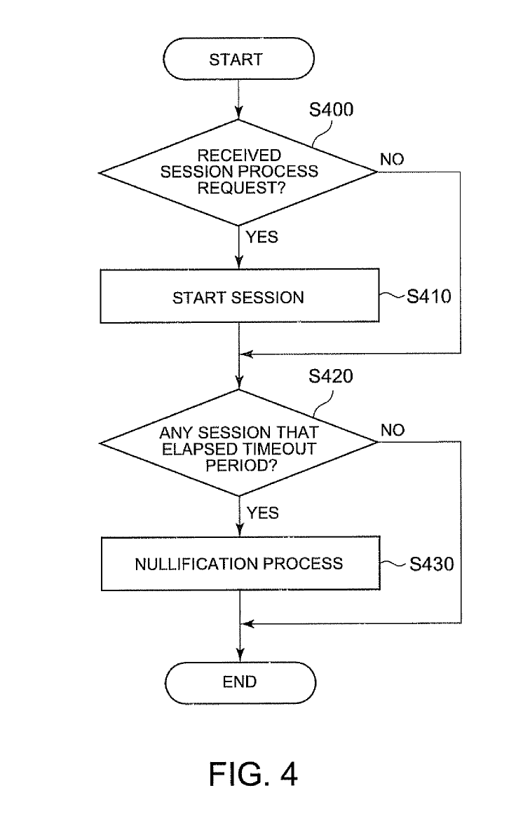

FIG. 4 shows an example of process flow of the server 20-1. The server device 20-1 repeats the process described below periodically, or every time any kinds of request from a terminal device is received. According to a session process request received from the terminal device 15 (S400:YES), the process portion 210 starts a session process (S410). For example, if a process of a first session has already been started, a process for a second session is started. In this instance, a session process request does not only mean a request that explicitly indicates starting of a new communication, but may include a communication request specifying a new session ID which is not stored in the storage portion 22Q. If a predetermined timeout period has elapsed without progress of the session (S420:YES), the nullification portion 230 nullifies the status information corresponding to the session being in processing in the storage portion 220 (S430).

More specifically, first, the nullification portion 230 acquires the last process time corresponding to each session from the information storage area 300 of the storage portion 220. Then, the nullification portion 230 determines whether or not the timeout period has elapsed by that moment, based on each last process time. Then, the storage portion 220 nullifies session in which the timeout period has elapsed since the last process time. For example, the nullification portion 230 may delete the session ID for the session from the storage portion 220, or release an area for the status information storage area corresponding to the session.

FIG. 5 shows an example of process flow when the server 20-1 takes over the process of the first session. The server device 20-1 performs the process described below when a user sends a login request to the server device 20-1, and a login request is processed properly. The determination portion 240 determines whether or not the identification information of the user logging in is already stored in the storage portion 220 in relation to the first session (S500). If the identification information is stored in relation to the first session (S500:YES), the determination portion 240 determines the condition whether or not the process of the first session should be taken over (S510).

If the condition is satisfied (S520:YES), the takeover portion 280 stores a first status information corresponding to the first session in the storage portion 220 in relation to the second session (S530). The process may be performed by updating the pointer as described with reference to FIG. 3. The nullification portion 230 nullifies the first session in the storage portion 220 under the condition that the first status information corresponding to the first session is stored in the storage portion 220 in relation to the second session (S540). For example, the nullification portion 230 may delete the session ID of the first session.

On the other hand, if the identification information for the user who logging in is not stored in the storage portion 220 (S500:NO), the determination portion 240 determines whether or not the identification information is stored in the storage portion of other server devices (S550). For example, the determination portion 240 performs a process to ask each of the server devices from 20-2 to 20-N shown in FIG. 1 whether or not the identification information is stored in the storage portion of any of the server devices 20-2 to 20-N.

If the identification information is stored in the storage portion of another server device (S550:YES), the determination portion 240 determines whether or not a process of another session (for example, the first session) corresponding to the identification information in the other server device is to be taken over (S560). If the condition is satisfied (S570:YES), the takeover portion 280 acquires the first status information of the first session from the storage portion of the other server device, and updates a second session information of a second session in the storage portion 220 of the server device 20-1 with the acquired first status information (S580). In this instance, the first session may be nullified in the storage portion of the other server device (S540).

In this instance, the process portion 210 performs the same process when the user newly logs in (S590). This process may be realized by conventional technology used in a usual web server, and thus the description is omitted.

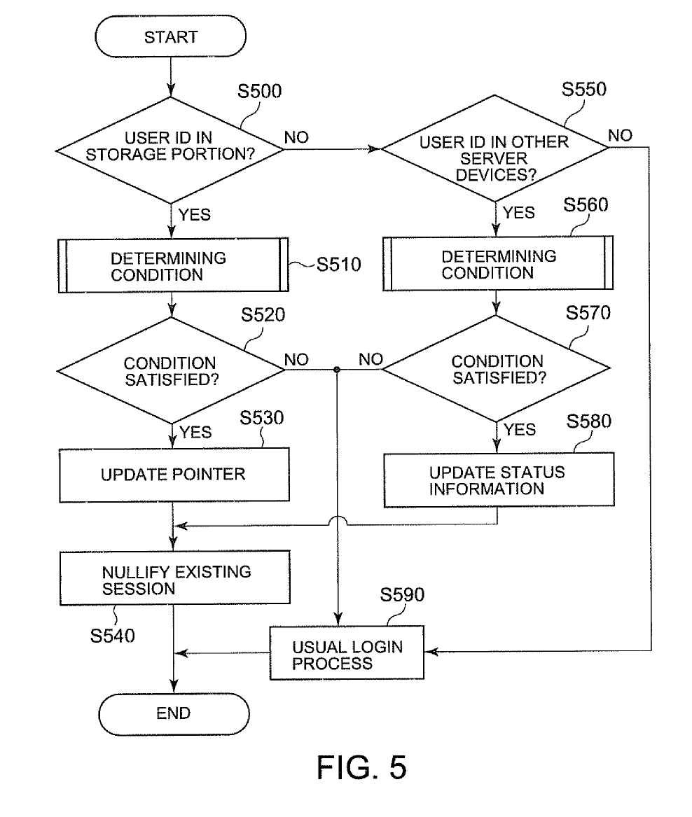

FIG. 6 shows an example of a process for determining the condition whether or not the first session is taken over in the server device 20-1. Processes in S510 and S560 in FIG. 5 are the same, and thus the explanation thereof is explained as one. First, the acquisition portion 250 acquires an elapsed time which elapsed without progress of the process of the first session (S600). The determination portion 240 determines whether or not the acquired elapsed time exceeds a predetermined period (S610). For example, the determination portion 240 may determine whether or not the acquired elapsed time exceeds a predetermined proportion of the timeout period.

If the elapsed time exceeds the predetermined time period (S610:YES), the display portion 270 displays an option indicating taking over the process of the first session and an option indicating starting a new process without taking over the process of the first session (S620). The input portion 200 accepts an order as to whether or not the process is taken over from the first session to the second session by allowing the user to choose one of the options. That is, the input portion 200 determines that an order to take over the process from the first session is input from the user when the user chooses the option indicating taking over of the process of the first session (S630).

If the takeover portion 280 receives an order to take over the first session (S640:YES) or the acquired elapsed time is smaller than a predetermined period (S610:NO), the takeover portion 280 determines that the condition is satisfied in order to take over the first session (S650). On the other hand, if the input order does not indicate takeover (S640:NO), the takeover portion 280 determines that the condition is not satisfied so that the first session is not taken over (S660).

In this ways according to the process of this figure, it is possible to forecast the possibility that the user will desire to take over the first session based on the elapsed time which has elapsed without progress of the process of the first session. That is, for example, when the web browser quits due to an erroneous operation or a malfunction, the user desires to continue the process and it is quite likely that the user starts the web browser immediately after that. In this case, the server device 20-1 can take over the first session without requiring the user to input an order, so that the convenience for the user is enhanced.

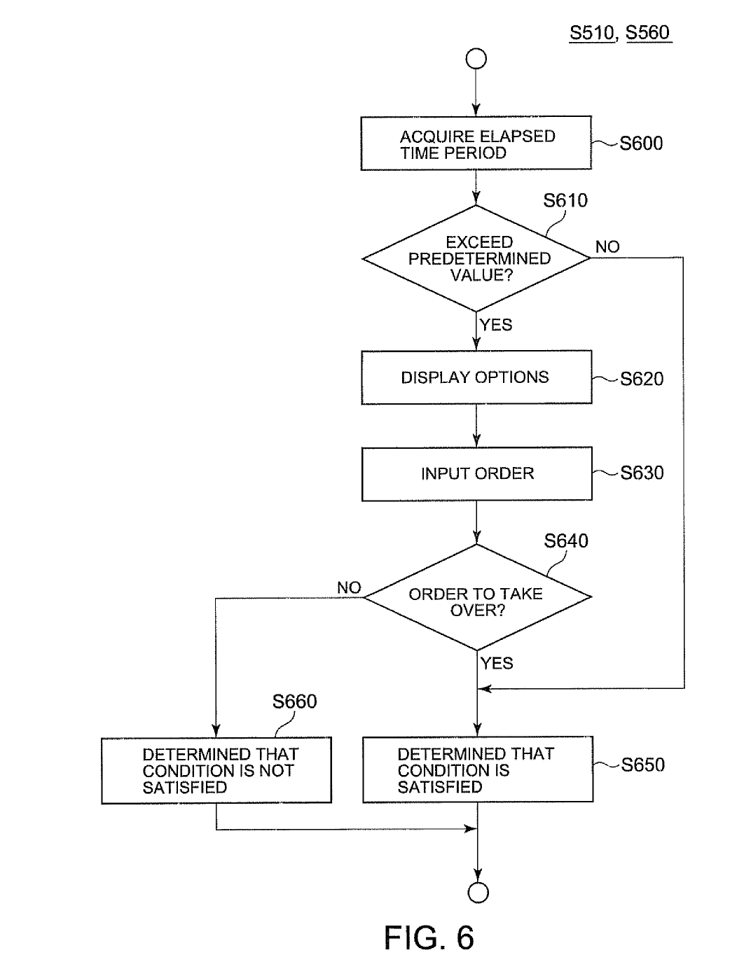

FIG. 7 shows an example of a login screen displayed in the terminal device 15 by the display portion 270. The display portion 270 displays a login screen for the user to log in when it receives a session request designating a predetermined URL, or a predetermined menu is selected. The login screen displays a service for the user (for example “XX Shopping Mall Site”), and an entry field for inputting an ID and a password to authenticate the user. The determination portion 240 determines that the user logging in, under the condition that the user is correctly authenticated based on the characters, and the like, input in the entry field.

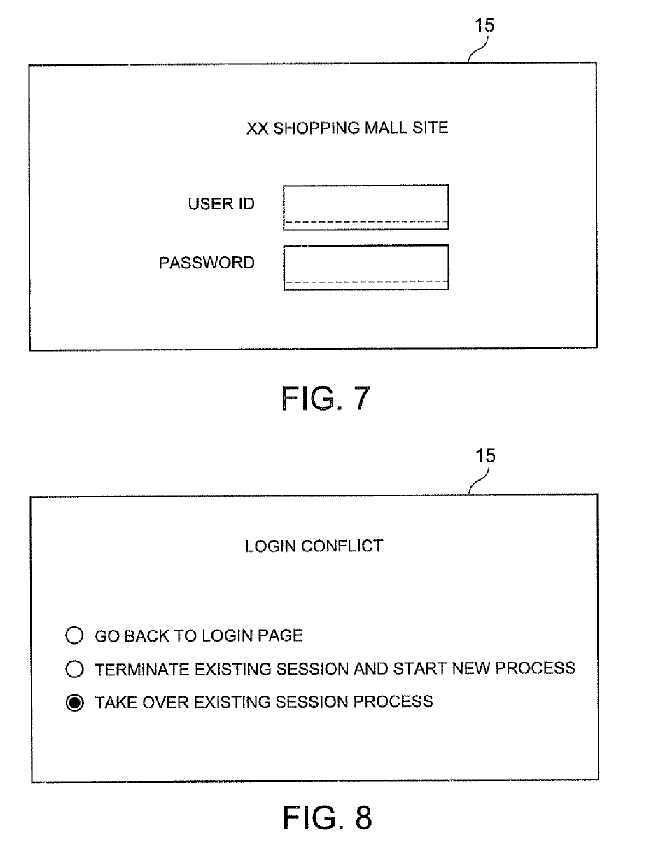

FIG. 8 shows an example of the options for selecting whether or not the first session is taken over, and displayed in the terminal device 15 by the display portion 270. The display portion 270 displays three options shown in this figure when the identification information of the user logging in the second session is already stored in the storage portion 220. A first option is “Go Back to Login Page”. In this option, the display portion 270 goes back to the screen shown in FIG. 7. If this option is selected, the user gives up logging in, and for example, the user can log in with another user ID. This is useful because when the web browser processing the first session is operating normally, the process can be continued.

A second option is “Terminate Existing Session and Start New Process”. In this option, the process portion 210 starts a new process in the second session without taking over the process of the first session. In this instance, the nullification portion 230 nullifies the first session in the storage portion 220. A third option is “Take Over Existing Session Process”. In this option, the takeover portion 280 takes over the process of the first session to the second session. In this instance, the nullification portion 230 also nullifies the first session in the storage portion 220.

In this display screen, the display control portion 260 may control a display priority displaying these options according to the elapsed time acquired by the acquisition portion 250. More specifically, when the acquired elapsed time is short, the option for taking over the process of the first session may be displayed prior to the other options in the display control portion 260. That is, for example, the display control portion 260 may display the option “Take Over Existing Session Process” in a place which can easily attract attention, such as on the top of the screen, when the elapsed time is quite short. Thereby, the takeover operation may be easily performed when there is a high possibility that the user made an erroneous operation, and thus convenience of the user can be enhanced.

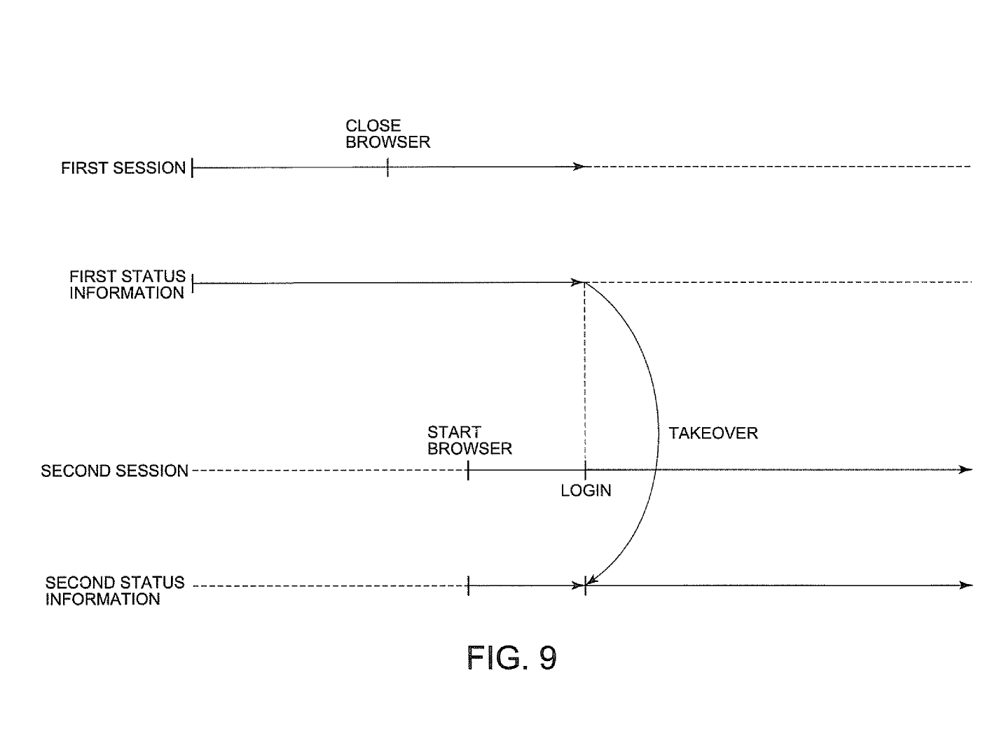

FIG. 9 shows a timing chart of a process which is taken over from the first session to the second session. Even when the web browser quits during the process of the first session, the server device 20-1 maintains the first status information as status information of the first session in the storage portion 220. However, the first status information is discarded when the timeout period has elapsed without progress of the process.

The process portion 210 starts a second session when a session process request is received from the newly launched web browser. In the second session, when the user is logging into the server device 20-11 the determination portion 240 determines whether or not the user ID of the user is stored in the storage portion 220. The takeover portion 280 takes over the process of the session to the second session, if the identification information of the user who logging in is stored in the storage portion 220 in relation to any of the sessions in which the status informations are effective. Thereafter, the interrupted process is restarted based on the status information.

In this way, according to the server device 20-1 of this embodiment, in a case where the session being in processing is interrupted by any malfunction, the session can be taken over to restart the process if the session is managed in the server device 20-1 as an active session. Thereby, the user can perform subsequent process efficiently without wasting the operations before the malfunction occurred. Moreover, the takeover process of the session is realized by a quite speedy process, such as the update of a pointer, and it offers high usability to the user.

Also, the server device 20-1 shown in this example reads out the process status from the memory area, in which the web server stores the process status in the normal operation, and takes it over to the second session. That is, a special function for storing the process status is not necessary for the application program in order to realize functions shown in this embodiment. Therefore, it is not necessary for the user to perform a special operation to store the status information. To realize the functions shown in this embodiment, the addition of a read-out order of subroutine which performs taking over of the session is suffice during login process in an existing application program. In this way, according to this embodiment, a session restart process can be added to various application programs with quite a low development cost.

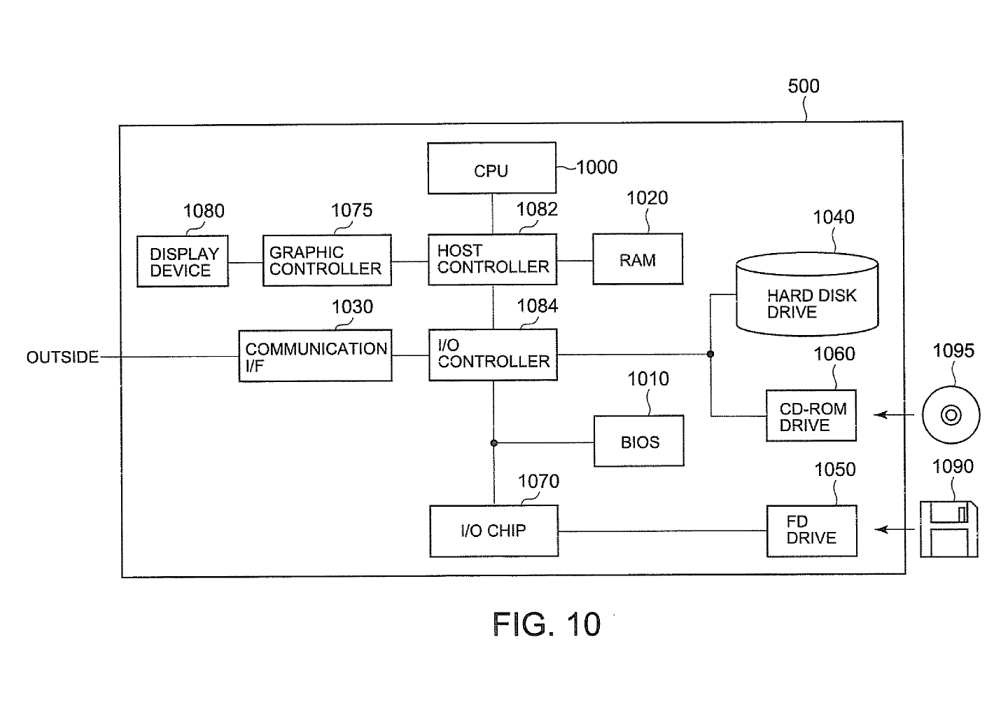

FIG. 10 shows an example of a hardware configuration of an information processing device 500 which serves as the server device 20-1. The information processing device 500 includes; a CPU peripheral portion having CPU 1000, a RAM 1020 and a graphic controller 1075 mutually connected via a host controller 1082; an input/output portion having a communication interface 1030, a hard disk drive 1040, and a CD-ROM drive 1060 connected to the host controller 1082 via an input/output controller 1084; and a legacy input-output portion having a BIOS 1010, a floppy disk drive 1050, and an input/output chip 1070 connected to the input/output controller 1084.

The host controller 1082 connects the RAM 1020 to the graphic controller 1075 and the CPU 1000 which access the RAM 1020 with a high transfer rate. The CPU 1000 operates based on a program stored in the BIOS 1010 and the RAM 1020, and controls each part. The graphic controller 1075 acquires image data generated on a frame buffer provided on the RAM 1020 by the CPU 1000 and the like, and displays it on the display device 1080. Alternately, the graphic controller 1075 may include the frame buffer which stores the graphic data generated by the CPU 1000 and the like.

The input/output controller 1084 connects the host controller 1082 to the communication interface 1030, the hard disk drive 1040, and the CD-ROM drive 1060 which are relatively high-speed input/output devices. The communication interface 1030 communicates with external devices via a network. The hard disk drive 1040 stores a program and data used by the information processing device 500. The CD-ROM drive 1060 reads out programs or data from a CD-ROM 1095, and offers it to the RAM 1020 or the hard disk drive 1040.

Also, the input/output controller 1084 is connected to relatively low-speed input/output devices such as the BIOS 1010, the floppy disk drive 1050, the input/output chip 1070, and the like. The BIOS 1010 stores a boot program performed by the CPU 1000 during start of up the information processing device 500, a program depending on the hardware of the information processing device 500, and the like. The floppy disk drive 1050 reads out a program or data from a floppy disk 1090, and offers it to the RAM 1020 or the hard disk drive 1040 via the input/output chip 1070. The input/output chip 1070 connects various input/output devices via the floppy disk 1090, or interfaces such as a parallel port, serial port, keyboard port, mouse port, and the like.

A program provided to the information processing device 500 is stored on a recording medium such as the floppy disk 1090, a CD-ROM 1095, an IC card, or the like, and provided by the user. The program is read out from the recording medium via the input/output chip 1070 and/or the input/output controller 1084, installed on the information processing device 500 to be performed. The operation of the server device 20-1 caused by the program is the same as the operations of the server device 20-1 described in FIG. 1 to FIG. 9, and thus the explanation is omitted.

The program described above may be stored in an external storage medium. As the storage medium, not only the floppy disk 1090, the CD-ROM 1095, but also an optical recording medium such as a DVD, a PD, and the like, and a semiconductor memory such as a tape medium, an IC card, and the like, may be used. Also, a storage device such as a hard disk or RAM provided in a server system connected to a dedicated communication network or the internet may be used as a recording medium in order to provide to a program to the information processing device 500 via a network.

Since the present invention is explained by using the embodiment described above, it should be noted here that the technical scope of the present invention is not limited to the above embodiment. For those skilled in the art, it is assumed that the various modifications and improvements may be included in the above embodiments. Also, from the scope of the claims, it is also assumed that those alternation and improvements to the embodiment of the invention may be included in the technical scope of the present invention.

While the invention has been shown and described with reference to particular embodiments thereof, it will be understood by those skilled in the art that the foregoing and other changes in form and detail may be made therein without departing from the spirit and scope of the invention.

1. A program product in a computer readable medium for causing an information processing system to function as a server performing a process in response to a request received from a terminal, wherein the program product causes the information processing system to function as:
a process portion, being capable of bringing a plurality of sessions concurrently in processing, for processing a session process request received from the terminal;
a storage portion for storing status information indicating a process status of a session, in correspondence to each of the sessions being in processing;
a determination portion for determining whether or not the process is to be taken over from a first session to a second session among the plurality of the sessions; and
a takeover portion for updating a second status information corresponding to the second session with a first status information corresponding to the first session, based on the determination of the determination portion.

2. The program product according to claim 1, wherein the determination portion determines to take over the process from the first session to the second session under a condition that the process status of the first session progresses more than the process status of the second session.

3. The program product according to claim 1, wherein
the process portion is able to cause a plurality of users to login concurrently and process a login request received from the terminal;
the storage portion further stores identification information of a user logging into the server for a session in correspondence to each of the sessions being in processing; and
the determination portion determines that the process is taken over from the first session to the second session under a condition that the first session and the second session have the same identification information assigned thereto.

4. The program product according to the claim 3, wherein
the program product further causes the information processing system to function as;
an input portion for accepting, from the user, an order indicating whether or not the process is taken over from the first session to the second session to which identification information of the user is assigned; and wherein
the determination portion determines that the process is to be taken over from the first session to the second session under a condition that the determination portion receives the order indicating that the process is to be taken over from the first session to the second session.

5. The program product according to claim 3, wherein
the process portion starts processing the session when the login request is properly processed.

6. The program product according to claim 3, wherein
the determination portion determines whether or not the process is to be taken over from the first session to the second session, based on a fact that the first session is in processing and the second session is started.

7. The program product according to the claim 3, wherein
regarding each of the sessions being in processing, the program product further causes the information processing system to function as a nullification portion for nullifying, in the storage portion, the status information corresponding to the following session, under a condition that a predetermined time period elapsed without progress of the session; and
wherein
the determination portion determines that the process is taken over from the first session to the second session under a condition that the identification information of the user logging in is stored in the storage portion, in correspondence to any of the sessions in which the status informations are effective.

8. The program product according to the claim 7, wherein
the program product further causes the information processing system to function as
an acquisition portion for acquiring elapsed time which elapsed without progress of the process status of the first session, under a condition that the identification information of the user logging in is already stored in the storage portion, in correspondence to the first session; and
an input portion in which the user inputs an order indicating whether or not the process of the first session is to be taken over and to be processed, under a condition that the elapsed time acquired is longer than a predetermined time period, and wherein
the determination portion determines to take over the process from the first session to the second session under a condition that the order indicating taking over the process of the first session for executing continuously is received, or the elapsed time acquired is smaller than the predetermined time period.

9. The program product according to claim 3, wherein
the program product causes the information processing system to function as a display portion for displaying options indicating taking over of the process of the first session and an option indicating starting a new process without taking over the process of the first session under a condition that the identification information of the user logging in is already stored in the storage portion in correspondence to the first session;
an input portion for determining that an order indicating taking over the first session is received when the option indicating taking over of the process of the first session is selected;
an acquisition portion for acquiring elapsed time which elapsed without progress of the process of the first session; and
a display control portion for displaying the option for taking over the process of the first session prior to other options in the display portion when the elapsed time which acquired is shorter, and wherein
the determination portion determines to take over the process from the first session to the second session under a condition that the order for continuously executing the first session is received.

10. The program product according to claim 1, wherein the storage portion comprises;
a plurality of first areas provided for each of the sessions being in processing and storing the status information of each of the sessions; and
a second area provided for the sessions being in processing for storing the identification information of the user logging in each session and a pointer for the first area corresponding to that session, and wherein
the takeover portion updates, in the second area, the second status information corresponding to the second session with the first status information corresponding the first session by storing the pointer for the first area corresponding the first session as the pointer for the first area corresponding to the second session.

11. The program product for causing the information processing system as one of a plurality of server devices for performing operation according to the request received from the terminal, according to claim 10, wherein
the determination portion determines whether or not the identification information is stored in the storage portion of another server under a condition that the identification information of the user logging in is not stored in the storage portion of the one of the server devices, and further determines to take over the process from the first session to the second session under a condition that the identification information is stored in the storage portion of the other server, and wherein
the takeover portion acquires the first status information stored corresponding to the identification information from the storage portion of the other server device, and updates the second status information corresponding to the second session in the storage portion of the server device with the first status information which is acquired.

12. The program product according to claim 1, wherein:
the takeover portion updates the second status information by copying the first status information to the second status information.

13. The program product according to claim 1, wherein
the program product further causing the information processing system to function as a nullification portion for nullifying the first session under a condition that the takeover portion stores, in the storage portion, the first status information corresponding to the first session as one corresponding to the second session.

14. A server device performing a process according to a request received from a terminal, comprising:
a process portion which is able to bring a plurality of sessions concurrently in processing, and processes a session process request received from the terminal;
a storage portion for storing status information indicating a process status of the session, in correspondence to each of the sessions being processed;
a determination portion for determining whether or not the process is to be taken over from a first session to a second session in the plurality of sessions; and
a takeover portion for updating a second status information corresponding to the second session with a first states information corresponding to the first session, based on the determination of the determination portion.

15. A management method for managing a session in a server device performing a process according to a request received from a terminal, wherein
the server device comprising a storage portion for storing status information indicating a process status of the session, in correspondence to each of the sessions being in processing; and wherein the method comprises:
a process step for processing a session process request received from the terminal;
a determination step for determining whether or not the process is to be taken over from a first session to a second session in the plurality of sessions; and
a takeover step for updating a second status information corresponding to the second session with a first states information corresponding to the first session, based on the determination of the determination portion.
